(19) United States
(12) Patent Application Publication
(10) Pub. No.: US 2026/0073918 A1
(43) Pub. Date: Mar. 12, 2026

(54) AUTO REPLY SYSTEM, AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventors: Masateru UDATE, Tokyo-to (JP); Yuta TSUZUKI, Tokyo-to (JP)

(73) Assignee: TOYOTA JIDOSHA KABUSHIKI KAISHA, Toyota-shi (JP)

(21) Appl. No.: 19/279,423

(22) Filed: Jul. 24, 2025

(30) Foreign Application Priority Data
Sep. 12, 2024 (JP) 2024-158500

(51) Int. Cl. G10L 15/22; G10L 15/30

(52) U.S. Cl. CPC G10L 15/22; G10L 15/30

(57) ABSTRACT

An auto reply device included in an auto reply system and mounted on a vehicle generates first reply information by inputting input information including voice information representing an utterance of an occupant of the vehicle into a first generation model that is pre-trained to generate the first reply information, generates inquiry information representing the utterance, based on the input information, and replies to the occupant, based on at least one of the first reply information and second reply information generated based on the inquiry information in a server provided outside the vehicle. The server generates the second reply information by inputting the inquiry information received from the auto reply device into a second generation model that is pre-trained to generate the second reply information and larger than the first generation model.

### FIELD

The present invention relates to an auto reply system that automatically replies to an utterance of an occupant of a vehicle, an auto reply device, an auto reply method, and a computer program for auto reply.

### BACKGROUND

A method for providing information depending on the preferences of an occupant of a vehicle has been proposed (see Japanese Unexamined Patent Publication No. 2023-124286). The method includes recognizing an occupant's action, based on position information of a vehicle and/or the occupant's voice, and storing an action record on the occupant's actions. The method further includes estimating the occupant's preferences related to information to be provided to the occupant, based on the voice, and adjusting the content of information to be provided to the occupant, based on the estimated preferences, when information on the action record is provided to the occupant.

### SUMMARY

In order for an occupant of a vehicle to feel satisfaction with a reply to the occupant's utterance, the reply needs to include appropriate details depending on the utterance.

It is an object of the present invention to provide an auto reply system that can reply to an utterance of an occupant in a vehicle appropriately.

According to an embodiment, an auto reply system is provided. The auto reply system includes an auto reply device mounted on a vehicle and a server provided outside the vehicle. The auto reply device includes a processor configured to: generate first reply information to an utterance of an occupant of the vehicle by inputting input information including voice information representing the utterance into a first generation model, generate inquiry information representing the utterance, based on the input information, transmit the inquiry information to the server via a communication device mounted on the vehicle, receive second reply information generated based on the inquiry information from the server, and reply to the occupant, based on at least one of the first and second reply information. The first generation model is implemented in the vehicle and pre-trained to generate the first reply information. The server includes a processor configured to generate the second reply information by inputting the inquiry information into a second generation model. The second generation model is pre-trained to generate the second reply information and is larger than the first generation model.

In an embodiment, the first generation model is pre-trained to generate the inquiry information, together with the first reply information, depending on the input information. The processor of the auto reply device generates the inquiry information by inputting the input information into the first generation model.

In an embodiment, the processor of the auto reply device makes a reply to the occupant, based on the generated first reply information, and further replies to the occupant after the reply, based on the second reply information received from the server.

In an embodiment, the processor of the auto reply device generates third reply information by inputting the second reply information into the first generation model, and replies to the occupant, based on the generated third reply information.

In an embodiment, the processor of the auto reply device notifies the occupant of a predetermined holding reply via a notification device mounted on the vehicle during a wait time from a reply to the occupant based on the first reply information until reception of the second reply information.

According to another embodiment, an auto reply method is provided. The auto reply method includes generating first reply information to an utterance of an occupant of a vehicle by inputting input information including voice information representing the utterance into a first generation model; generating inquiry information representing the utterance, based on the input information; generating second reply information to the inquiry information by inputting the inquiry information into a second generation model provided outside the vehicle; and replying to the occupant, based on at least one of the first and second reply information. The first generation model is implemented in the vehicle and pre-trained to generate the first reply information. The second generation model is pre-trained to generate the second reply information and larger than the first generation model.

According to still another embodiment, a non-transitory recording medium that stores a computer program for auto reply is provided. The computer program includes instructions causing a computer to execute a process including generating first reply information to an utterance of an occupant of a vehicle by inputting input information including voice information representing the utterance into a first generation model; generating inquiry information representing the utterance, based on the input information; generating second reply information to the inquiry information by inputting the inquiry information into a second generation model provided outside the vehicle; and replying to the occupant, based on at least one of the first and second reply information. The first generation model is implemented in the vehicle and pre-trained to generate the first reply information. The second generation model is pre-trained to generate the second reply information and larger than the first generation model.

According to yet another embodiment, an auto reply device is provided. The auto reply device includes a processor configured to: generate first reply information to an utterance of an occupant of a vehicle by inputting input information including voice information representing the utterance into a first generation model, generate inquiry information representing the utterance, based on the input information, transmit the inquiry information to a server provided outside the vehicle via a communication device mounted on the vehicle, receive second reply information generated based on the inquiry information from the server, and reply to the occupant, based on at least one of the first and second reply information. The first generation model is implemented in the vehicle and pre-trained to generate the first reply information.

The auto reply system of the present disclosure has an advantageous effect of being able to reply to an utterance of an occupant in a vehicle appropriately.

### BRIEF DESCRIPTION OF DRAWINGS

FIG. 1 schematically illustrates the configuration of an auto reply system.

FIG. 2 schematically illustrates the configuration of a vehicle equipped with an auto reply device.

FIG. 3 illustrates the hardware configuration of the auto reply device.

FIG. 4 is a functional block diagram of a processor of the auto reply device.

FIG. 5 illustrates the hardware configuration of a server.

FIG. 6 is a functional block diagram of a processor of the server.

FIG. 7A illustrates an auto reply process.

FIG. 7B illustrates an auto reply process.

FIG. 8 is an operation flowchart of the auto reply process.

### DESCRIPTION OF EMBODIMENTS

An auto reply system, an auto reply method and a computer program for auto reply executed by the auto reply system, and an auto reply device included in the auto reply system will now be described with reference to the attached drawings. The auto reply system includes an auto reply device mounted on a vehicle and a server provided outside the vehicle. The auto reply device generates first reply information to an utterance of an occupant of the vehicle, using a first generation model implemented in the vehicle, and transmits inquiry information depending on the utterance to the server. The server generates second reply information to the received inquiry information by inputting the inquiry information into a second generation model larger than the first generation model, and transmits the generated second reply information to the vehicle. Upon receiving the second reply information from the server, the auto reply device replies to the occupant, based on at least one of the first and second reply information.

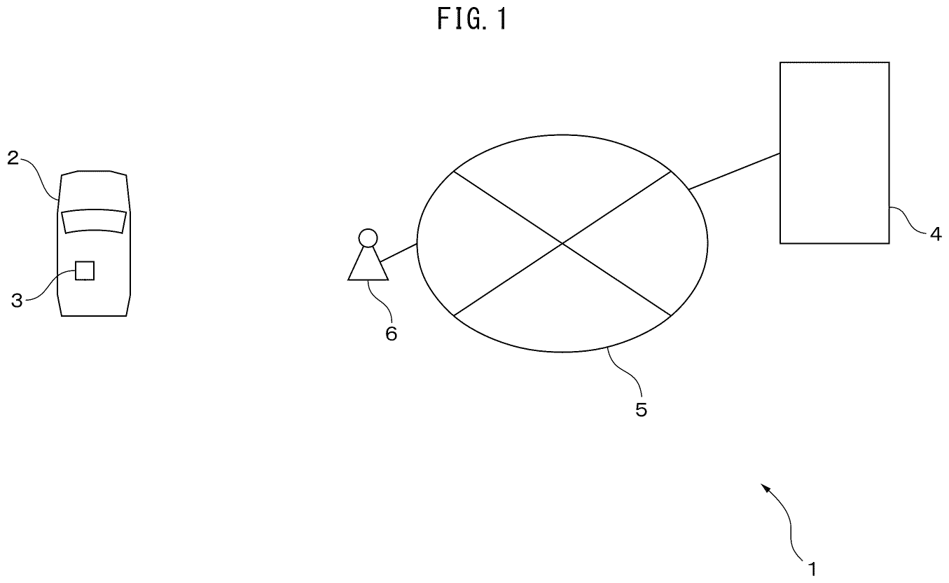

FIG. 1 schematically illustrates the configuration of an auto reply system. In the present embodiment, the auto reply system 1 includes an auto reply device 3 mounted on a vehicle 2 and a server 4. The auto reply device 3 accesses a wireless base station 6, which is connected via a gateway (not illustrated) to a communication network 5 connected with the server 4, thereby connecting to the server 4 via the wireless base station 6 and the communication network 5. FIG. 1 illustrates only a single vehicle 2 and a single auto reply device 3, but the auto reply system 1 may include multiple vehicles 2 each equipped with an auto reply device 3. Similarly, the communication network 5 may be connected with multiple wireless base stations 6.

First, the vehicle 2 and the auto reply device 3 will be described. The auto reply system 1 may include multiple vehicles 2 each equipped with an auto reply device 3 as described above, but the following describes a single vehicle 2 and a single auto reply device 3 because each vehicle 2 and each auto reply device 3 have the same configuration and execute the same processing in relation to an auto reply process.

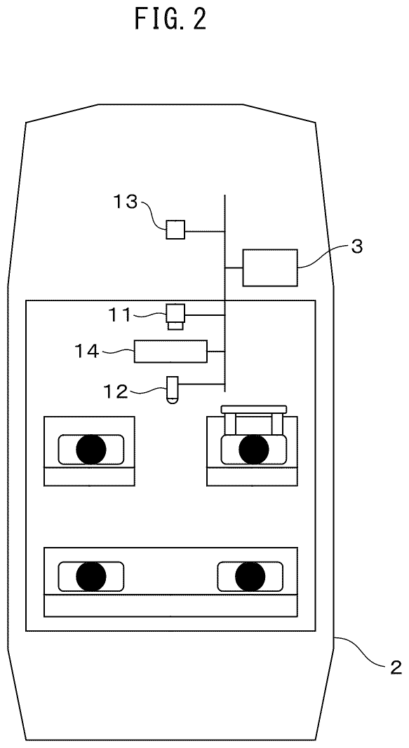

FIG. 2 schematically illustrates the configuration of a vehicle 2 equipped with an auto reply device 3. The vehicle 2 includes a camera 11, at least one microphone 12, a wireless communication terminal 13, a notification device 14, and an auto reply device 3. The camera 11, the microphone 12, the wireless communication terminal 13, and the notification device 14 are communicably connected to the auto reply device 3.

The camera 11, which is an example of a vehicle interior sensor, is installed near the top of the windshield and oriented to the vehicle interior so that all the occupants in the vehicle 2 are included in the region to be captured by the camera. Every predetermined capturing period, the camera 11 generates an image representing the interior of the vehicle 2 and outputs the generated image to the auto reply device 3. An image generated by the camera 11 will be referred to as an “interior image,” below. An interior image is an example of an interior sensor signal.

The at least one microphone 12, which is another example of a vehicle interior sensor, picks up a voice of an occupant in the vehicle 2 and outputs a voice signal representing the voice. To achieve this, each microphone 12 is installed in the interior of the vehicle 2. Multiple microphones 12 may be arrayed, or installed near respective seats in the interior of the vehicle 2. Each microphone 12 outputs a generated voice signal to the auto reply device 3. A voice signal generated by an individual microphone 12 is another example of an interior sensor signal.

The wireless communication terminal 13, which is an example of the communication device, is a device to execute a wireless communication process conforming to a predetermined standard of wireless communication, and accesses, for example, the wireless base station 6 to connect to the server 4 via the wireless base station 6 and the communication network 5. In other words, a communication channel is established between the wireless communication terminal 13 and the server 4 via the wireless base station 6 and the communication network 5. The wireless communication terminal 13 generates an uplink radio signal including inquiry information received from the auto reply device 3, and transmits the radio signal to the wireless base station 6. In this way, inquiry information is transmitted to the server 4. Further, the wireless communication terminal 13 receives a downlink radio signal including second reply information from the wireless base station 6, and outputs the second reply information to the auto reply device 3. In this way, second reply information generated by the server 4 is transmitted to the auto reply device 3.

The notification device 14 is provided in the interior of the vehicle 2 and notifies an occupant of a reply represented by reply information generated by the auto reply device 3 or the server 4. To achieve this, the notification device 14 includes, for example, at least one of a speaker or a display. When a notification signal representing a reply to an occupant is received from the auto reply device 3, the notification device 14 notifies the occupant of the reply by a voice from the speaker or by displaying a message, an image, or a video on the display. For each seat, a display or a speaker included in the notification device 14 may be installed and oriented to an occupant sitting on the seat.

The auto reply device 3 generates first reply information to an utterance of an occupant of the vehicle 2. In addition, the auto reply device 3 generates inquiry information representing the utterance, and transmits the generated inquiry information to the server 4 via the wireless communication terminal 13. In addition, the auto reply device 3 receives second reply information to the inquiry information from the server 4 via the wireless communication terminal 13. The auto reply device 3 then replies to the occupant, based on at least one of the first and second reply information.

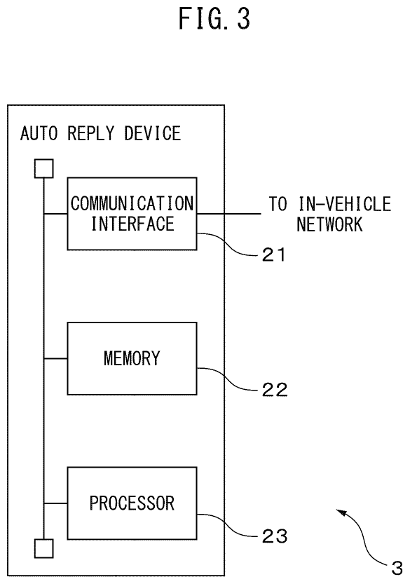

FIG. 3 illustrates the hardware configuration of the auto reply device 3. As illustrated in FIG. 3, the auto reply device 3 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 3 to another device inside the vehicle. The communication interface 21 passes an interior image received from the camera 11 and voice signals received from the individual microphones 12 to the processor 23. The communication interface 21 outputs a notification signal received from the processor 23 to the notification device 14 or a control command received from the processor 23 to a vehicle-mounted device. In addition, the communication interface 21 outputs inquiry information received from the processor 23 to the wireless communication terminal 13, and conversely, outputs second reply information received from the wireless communication terminal 13 to the processor 23.

The memory 22, which is an example of a storage unit, includes, for example, volatile and nonvolatile semiconductor memories, and stores various types of data used in an auto reply process executed by the processor 23. More specifically, the memory 22 stores a set of parameters specifying a first generation model for generating reply information. In addition, the memory 22 may temporarily store interior images received from the camera 11 and voice signals received from the individual microphones 12. In addition, the memory 22 temporarily stores second reply information. The memory 22 further stores a holding reply message for notification during a wait time until reception of second reply information is finished.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes an auto reply process.

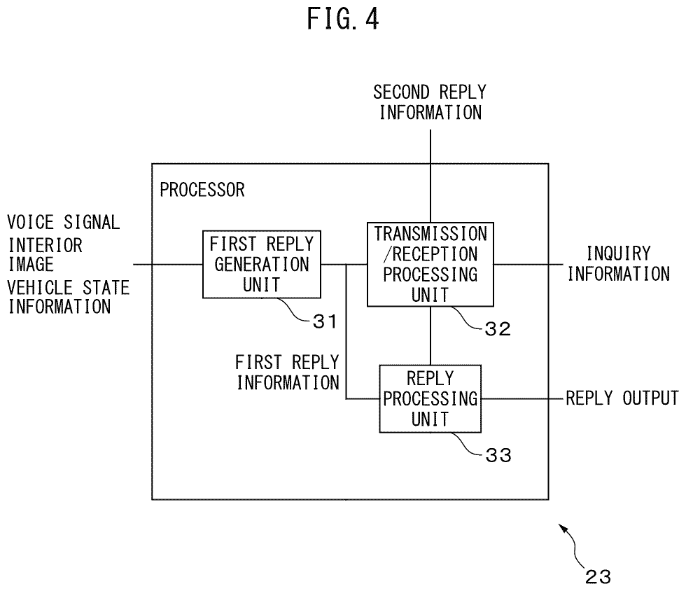

FIG. 4 is a functional block diagram of the processor 23, related to the auto reply process. The processor 23 includes a first reply generation unit 31, a transmission/reception processing unit 32, and a reply processing unit 33. These units included in the processor 23 are, for example, functional modules implemented by a computer program executed by the processor 23, or may be dedicated operating circuits provided in the processor 23.

The first reply generation unit 31 generates first reply information to an utterance of an occupant of the vehicle 2 by inputting predetermined input information including voice information representing the utterance into a first generation model. In addition, the first reply generation unit 31 generates inquiry information depending on the utterance.

To generate voice information representing an utterance, the first reply generation unit 31 inputs a voice signal whose average volume in a most recent predetermined period exceeds an utterance detection threshold among voice signals generated by the individual microphones 12 into a voice recognition model, thereby recognizing an utterance represented by the voice signal, and generates a character string representing the utterance as voice information. Such a voice recognition model is configured, for example, as a deep neural network (DNN) having an attention mechanism or a DNN having a recursive structure, such as a recurrent neural network (RNN) or Long Short-Term Memory (LSTM). Alternatively, the voice recognition model may be configured as a GMM-HMM based on a mixture Gaussian distribution and a hidden Markov model or as a DNN-HMM based on a DNN and a hidden Markov model. The first reply generation unit 31 may divide a voice signal into frames each having a predetermined length of time, extract a feature of the voice for each frame, and input the feature of each frame into the voice recognition model in chronological order, thereby recognizing an utterance represented by the voice signal. The feature of each frame may be, for example, a predetermined element of the cepstrum of the frame.

In the present embodiment, the first generation model is configured as large language models (LLM). The LLM that is the first generation model is configured, for example, as one with multiple stacked blocks each including an attention layer and a feed forward layer. The first reply generation unit 31 inputs a character string representing an utterance into the LLM. The first generation model then outputs text data representing a reply corresponding to the utterance as first reply information.

First reply information is not limited to information including a reply to be notified to each occupant via the notification device 14, and may include a reply for controlling the vehicle 2 itself or a device mounted on the vehicle 2.

The first generation model is a generation model with a relatively small operation scale so that even if implemented in the processor 23 of the vehicle-mounted auto reply device 3, first reply information can be generated in such a short time that an occupant does not feel stressed by the occupant's utterance. For this reason, a reply included in first reply information generated by the first generation model is simpler than a reply included in second reply information generated by a second generation model.

According to a modified example, the first reply generation unit 31 may include an interior image or a sub-region representing an individual occupant in an interior image, together with voice information, in input information to be inputted into the first generation model. In this case, the first generation model is configured as a vision language model (VLM). By an interior image or a sub-region representing an occupant being inputted in this way, the first generation model can generate first reply information by referring to the state of the occupant.

When a sub-region representing an occupant is inputted into the generation model, the first reply generation unit 31 detects a sub-region representing an occupant by inputting an interior image into a classifier that is pre-trained to detect an occupant. The classifier for occupant detection is configured as a convolutional neural network (CNN), such as Single Shot MultiBox Detector or Faster R-CNN, or a DNN having an attention mechanism, such as Vision Transformer.

When a sub-region representing an occupant is inputted into the first generation model, the first reply generation unit 31 crops, for each occupant, a sub-region representing the occupant from an interior image, or masks the region other than sub-regions representing individual occupants by changing the values of individual pixels included in the region other than the sub-regions to a predetermined pixel value.

In input information, the first reply generation unit 31 may further include at least one of the following: the current position of the vehicle 2, a destination, a sensor signal obtained by a sensor provided for the vehicle 2 to sense motion of the vehicle 2, the condition of the vehicle interior, or the condition of an area around the vehicle 2, the amount of operation of the vehicle 2 by an occupant, and a signal indicating the setting of a vehicle-mounted device. The sensor for sensing motion of the vehicle 2 is, for example, a speed sensor or an acceleration sensor. The sensor for sensing the condition of the interior of the vehicle 2 or an area around the vehicle 2 is, for example, a thermometer, an illuminometer, or a rainfall sensor. The amount of operation of the vehicle 2 by an occupant is, for example, the accelerator position, the amount of braking, or the steering angle. The setting of a vehicle-mounted device is, for example, the temperature setting of an air conditioner, the airflow setting, the open/closed state of a window, and the volume setting of an audio. The current position of the vehicle 2 is determined by a position determining device (not illustrated) mounted on the vehicle 2; the position determining device is one based on a satellite positioning system, such as a GPS receiver. The destination of the vehicle 2 is obtained from a navigation device (not illustrated) mounted on the vehicle 2. These signals and pieces of information will be referred to as “vehicle state information,” below. By vehicle state information being inputted, the first generation model can refer to the state of the vehicle 2 or a vehicle-mounted device and thus generate more appropriate reply information as first reply information.

The first reply generation unit 31 converts the types and signal values of sensor signals included in vehicle state information to a character string, and joins the converted character string to a character string representing voice information, thereby generating text data to be inputted into the first generation model. Alternatively, the first generation model may include an input layer for inputting vehicle state information, separately from a block into which voice information is inputted. In this case, only a character string corresponding to voice information is inputted into the block closest to the input side of the multiple stacked blocks, and vehicle state information is inputted into the input layer for inputting vehicle state information. The vehicle state information inputted into the input layer is taken in a block having a cross attention mechanism that calculates cross attention of the vehicle state information and output from an upstream block among the multiple stacked blocks included in the generation model. In this case, a tuning technique such as LoRA may be applied to training of the first generation model related to taking in vehicle state information.

The first reply generation unit 31 further generates inquiry information. To this end, the first reply generation unit 31 includes all the input information to be inputted into the first generation model in inquiry information. Alternatively, the first generation model may be configured to generate inquiry information, together with first reply information, based on input information. In this case, the first generation model is configured to include multiple stacked blocks bifurcating in the middle so that one or more blocks for generating first reply information and one or more blocks for generating inquiry information are provided in parallel. Each block downstream of the bifurcation is also configured to include an attention layer and a feed forward layer. First reply information and inquiry information are determined separately according to output probabilities calculated by a softmax operation of output from the corresponding last blocks. In this case also, a tuning technique such as LoRA may be applied to training of the first generation model related to first reply information or inquiry information added to a base model. The first generation model is pre-trained to output text data in which the main point of an utterance represented in inputted voice information is clarified as inquiry information. For example, when the utterance of an occupant is “How long will it take to get to ‘AA’?” the first generation model outputs text data such as “What is the estimated time required to get from ‘BB’ to ‘AA’?” (‘BB’ is the current position of the vehicle 2) as inquiry information. By the first generation model generating inquiry information in this way from a voice signal representing an occupant's utterance, the first reply generation unit 31 can generate inquiry information in which the main point of the utterance is more clarified.

The first reply generation unit 31 outputs the first reply information to the reply processing unit 33 and the inquiry information to the transmission/reception processing unit 32.

Upon receiving inquiry information, the transmission/reception processing unit 32 includes identifying information of the vehicle 2 or the wireless communication terminal 13 mounted on the vehicle 2 in the inquiry information. The transmission/reception processing unit 32 then transmits the inquiry information including identifying information of the vehicle 2 or the wireless communication terminal 13 to the server 4 via the wireless communication terminal 13.

In addition, after starting reception of second reply information from the server 4 via the wireless communication terminal 13, the transmission/reception processing unit 32 successively outputs received portions of second reply information to the reply processing unit 33.

The reply processing unit 33 executes a reply process to reply to the occupant of the vehicle 2, based on at least one of the first and second reply information. In the present embodiment, the reply process includes not only giving notification to an occupant via the notification device 14 according to reply information but also controlling the vehicle 2 or one of various devices mounted on the vehicle 2 according to reply information.

Upon receiving first reply information, the reply processing unit 33 generates a notification signal representing a reply included in the first reply information, and outputs the generated notification signal to the notification device 14 via the communication interface 21. For example, based on the text data representing a reply included in the first reply information, the reply processing unit 33 generates a voice signal representing the reply as a notification signal in accordance with a predetermined speech synthesis technique. The reply processing unit 33 then outputs the notification signal to the speaker included in the notification device 14, causing the speaker to output a voice representing the reply. Alternatively, the reply processing unit 33 includes the text data representing a reply in the notification signal, and then causes the text data representing a reply to appear on the display included in the notification device 14.

In addition, the reply processing unit 33 controls a device specified by the reply included in the first reply information according to the reply. The reply processing unit 33 determines a device to be controlled and a control command by referring to a reference table for control representing the correspondence between text data representing a reply included in first reply information, a device to be controlled (including the vehicle 2 itself), and a control command for executing the control. The reply processing unit 33 then outputs the determined control command to an electronic control unit (ECU) of the device to be controlled, via the communication interface 21.

Besides an air conditioner, devices to be controlled may include a window, a door lock, an indoor light, or a seat. As control of a device according to a reply, the reply processing unit 33 opens or closes a window, locks or unlocks a door, turns on or off an indoor light, or adjusts the position of a seat where an occupant is sitting.

When the text data representing a reply does not include any of words that specify a device to be controlled and that are registered in the reference table for control, the reply information is not aimed at controlling a device. Thus, in this case, the reply processing unit 33 does not output a control signal.

After reply output based on the first reply information is finished, the reply processing unit 33 replies according to second reply information. To this end, the reply processing unit 33 executes, on second reply information, a process that is the same as the reply process based on first reply information. When the reply included in second reply information is the same as that included in the first reply information, the reply processing unit 33 may omit to reply according to the second reply information.

The reply processing unit 33 may generate third reply information by inputting second reply information into the first generation model. In this case, the first generation model is pre-trained so that not only is first reply information (and further inquiry information in some cases) generated upon input of the above-described input information, but also reply output to an occupant is generated depending on input upon input of text data representing a reply included in second reply information. Thus the reply processing unit 33 inputs text data representing a reply included in second reply information into the first generation model. Based on the third reply information, the reply processing unit 33 then executes a reply process that is the same as the reply process based on first reply information. The reply processing unit 33 can reply to an occupant more naturally, based on third reply information generated in this way by reusing the first generation model used for generating first reply information. When generating third reply information, the reply processing unit 33 may input text data obtained by joining text data representing a reply included in first reply information to text data representing a reply included in second reply information into the first generation model. This enables the reply processing unit 33 to improve the consistency between the reply included in first reply information and the reply included in third reply information.

According to a modified example, the reply processing unit 33 may omit to execute the reply process based on first reply information until reception of second reply information is finished, and may generate third reply information with the first generation model, as described above, when reception of second reply information is finished. The reply processing unit 33 may then execute the reply process based on the third reply information.

According to another modified example, the reply processing unit 33 may omit to execute the reply process based on first reply information, and may execute the reply process based on second reply information when reception of second reply information is finished.

According to still another modified example, in the case where reception of second reply information is not finished when the reply process based on first reply information is finished, the reply processing unit 33 may notify the occupant of a predetermined holding reply message via the notification device 14 in a wait time from when the reply process based on first reply information is finished until reception of second reply information is finished. The holding reply message may be, for example, a message for informing an occupant that the reply is not finished, such as “Please wait a moment” or “Now inquiring.” Notification of such a holding reply message to an occupant prevents non-response even if there is a time difference between completion of the reply process based on first reply information and reception of second reply information. The reply processing unit 33 can therefore reply to the occupant more naturally.

In the case where second reply information is being received when the reply process based on first reply information is finished, the reply processing unit 33 may input part of second reply information received by the time into the first generation model to generate a holding reply message. When a flag indicating the end of second reply information is included in the received portion of second reply information, the reply processing unit 33 determines that reception of second reply information is finished; when the flag is not included, the reply processing unit 33 determines that second reply information is being received. In this case, every time a portion of second reply information is received, the reply processing unit 33 may input the received portion into the first generation model successively. The reply processing unit then uses text data that has been outputted from the first generation model when the reply process based on first reply information is finished, as a holding reply message. Alternatively, when the reply process based on first reply information is finished, the reply processing unit 33 may input text data that has been outputted from the first generation model based on successively inputted portions of second reply information into the first generation model again, thereby generating a holding reply message. In the case where the length of text data included in a received portion of second reply information is less than a predetermined lower-limit threshold when the reply process based on first reply information is finished, the reply processing unit 33 may give notification of a holding reply message pre-stored in the memory 22 via the notification device 14. This prevents notification of a meaningless holding reply message from being given because a received portion of second reply information is too small when the reply process based on first reply information is finished.

The following describes the server 4. The server 4, in which a second generation model is implemented, generates second reply information to inquiry information, using the second generation model.

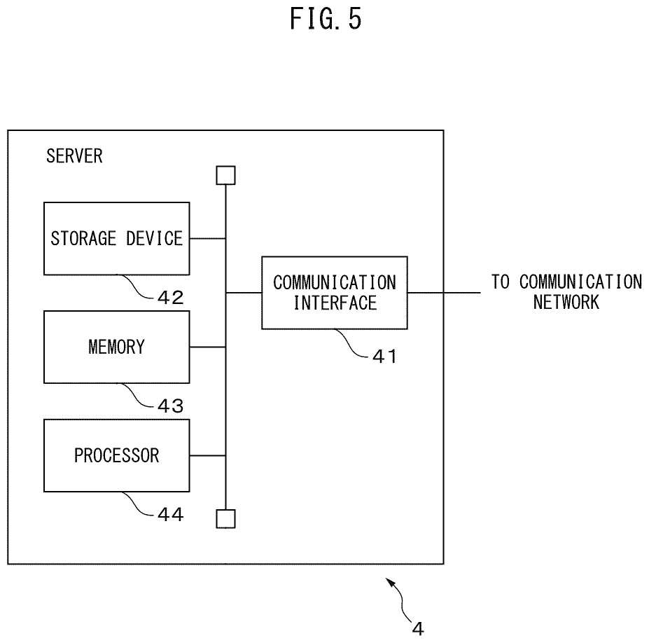

FIG. 5 illustrates the hardware configuration of the server 4. The server 4 includes a communication interface 41, a storage device 42, a memory 43, and a processor 44. The communication interface 41, the storage device 42, and the memory 43 are connected to the processor 44 via a signal line.

The communication interface 41, which is an example of a communication unit, includes an interface circuit for connecting the server 4 to the communication network 5. The communication interface 41 is configured to be communicable with the auto reply device 3 mounted on the vehicle 2 via the communication network 5, the wireless base station 6, and the wireless communication terminal 13 mounted on the vehicle 2. More specifically, the communication interface 41 passes inquiry information received from the auto reply device 3 of the vehicle 2 via the wireless communication terminal 13, the wireless base station 6, and the communication network 5 to the processor 44. Further, the communication interface 41 transmits second reply information received from the processor 44 via the communication network 5, the wireless base station 6, and the wireless communication terminal 13 of the vehicle 2 to the auto reply device 3 of the vehicle 2. In addition, the communication interface 41 passes various types of information received from another server connected via the communication network 5 (e.g., a server delivering traffic information or weather information) to the processor 44.

The storage device 42 includes, for example, a solid-state drive, a hard disk drive, or an optical medium and an access device therefor. The storage device 42 stores a set of parameters specifying the second generation model and other data. The storage device 42 may further store identifying information of the vehicle 2 or the wireless communication terminal 13 mounted on the vehicle 2, a computer program for the processor 44 to execute an auto reply process on the server 4 side, and various types of information received from another server.

The memory 43 includes, for example, nonvolatile and volatile semiconductor memories. The memory 43 temporarily stores various types of data generated during execution of the auto reply process or used in the auto reply process.

The processor 44 includes one or more central processing units (CPUs) and a peripheral circuit thereof. The processor 44 may further include another operating circuit, such as a logic-arithmetic unit or an arithmetic unit. The processor 44 executes the auto reply process on the server 4 side.

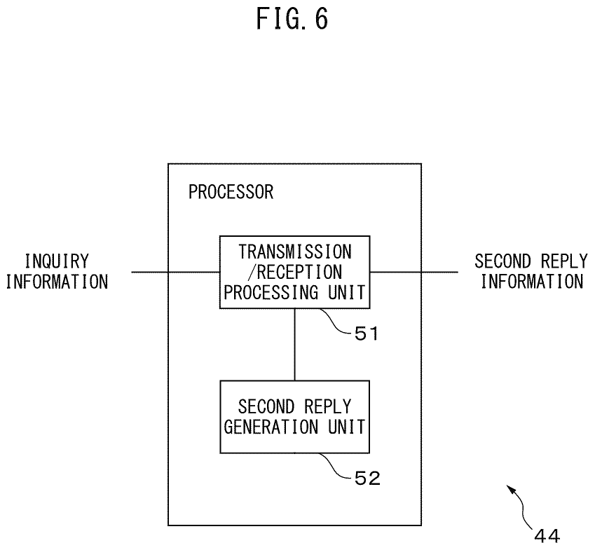

FIG. 6 is a functional block diagram of the processor 44, related to the auto reply process on the server side. The processor 44 includes a transmission/reception processing unit 51 and a second reply generation unit 52. These units included in the processor 44 are, for example, functional modules implemented by a computer program executed by the processor 44, or may be dedicated operating circuits provided in the processor 44.

Upon receiving inquiry information from the auto reply device 3 of the vehicle 2, the transmission/reception processing unit 51 outputs information to be inputted into the second generation model in the inquiry information (e.g., text data, an interior image, and vehicle state information) to the second reply generation unit 52. Upon receiving second reply information from the second reply generation unit 52, the transmission/reception processing unit 51 identifies the vehicle 2 or the wireless communication terminal 13 mounted on the vehicle 2 that has transmitted inquiry information, by referring to identifying information of the vehicle 2 or the wireless communication terminal 13 included in the inquiry information. The transmission/reception processing unit 51 then transmits the second reply information to the identified wireless communication terminal 13 of the vehicle 2 via the communication interface 41, the communication network 5, and the wireless base station 6. Specifically, the transmission/reception processing unit 51 transmits second reply information after the second generation model finishes generating the second reply information. Alternatively, every time the second generation model outputs a portion of second reply information (e.g., text data of a predetermined number of characters or words), the transmission/reception processing unit 51 may transmit the portion of second reply information.

The second reply generation unit 52 generates second reply information by inputting text data included in inquiry information into the second generation model. When the inquiry information includes an interior image or a sub-region representing an occupant in an interior image, the second reply generation unit 52 also inputs the interior image or the sub-region into the second generation model. Similarly, when the inquiry information includes vehicle state information, the second reply generation unit 52 also inputs the vehicle state information into the second generation model.

The second generation model is configured as a LLM (or a VLM in the case where an interior image or a sub-region is also inputted), similarly to the first generation model. The second generation model is larger than the first generation model, and is configured so as to include, for example, a greater number of blocks including an attention mechanism and a feed forward layer than the first generation model. The data set used for training the second generation model is greater than the data set used for training the first generation model. For this reason, the second generation model executes a greater amount of computation than the first generation model, but can generate second reply information including a more detailed or accurate reply than first reply information generated by the first generation model. For example, when the utterance of an occupant is a request for description about a particular thing or event, the second generation model can generate second reply information including more detailed or accurate description about the thing or event than first reply information generated by the first generation model. For example, when the utterance of an occupant is “Tell me about ‘CC’ building,” first reply information generated by the first generation model includes relatively simple information such as “‘CC’ building is located in ‘DD’.” In contrast, second reply information generated by the second generation model includes more detailed information such as “‘CC’ building is located in ‘DD’ and is ‘EE’ meters high. There is a famous restaurant called ‘FF’ there.” When the utterance of an occupant is “How long will it take to get to ‘GG’?” first reply information generated by the first generation model is an inquiry to a navigation device mounted on the vehicle 2 about estimated time required to reach ‘GG’ from the current position of the vehicle 2, and as a result of the inquiry, includes a reply such as “In ‘HH’ minutes”. In contrast, second reply information generated by the second generation model is made by referring to the latest traffic information provided from a traffic information server and a search result of a route from the current position of the vehicle 2 to a destination obtained by a route searching algorithm implemented on the server 4 side, and as a result, represents more accurate estimated time required to reach the destination.

When second reply information is generated by the second generation model, the second reply generation unit 52 outputs the second reply information to the transmission/reception processing unit 51. Every time the second generation model outputs a portion of second reply information, e.g., text data of a predetermined number of characters, the second reply generation unit 52 may transmit the portion of second reply information to the transmission/reception processing unit 51.

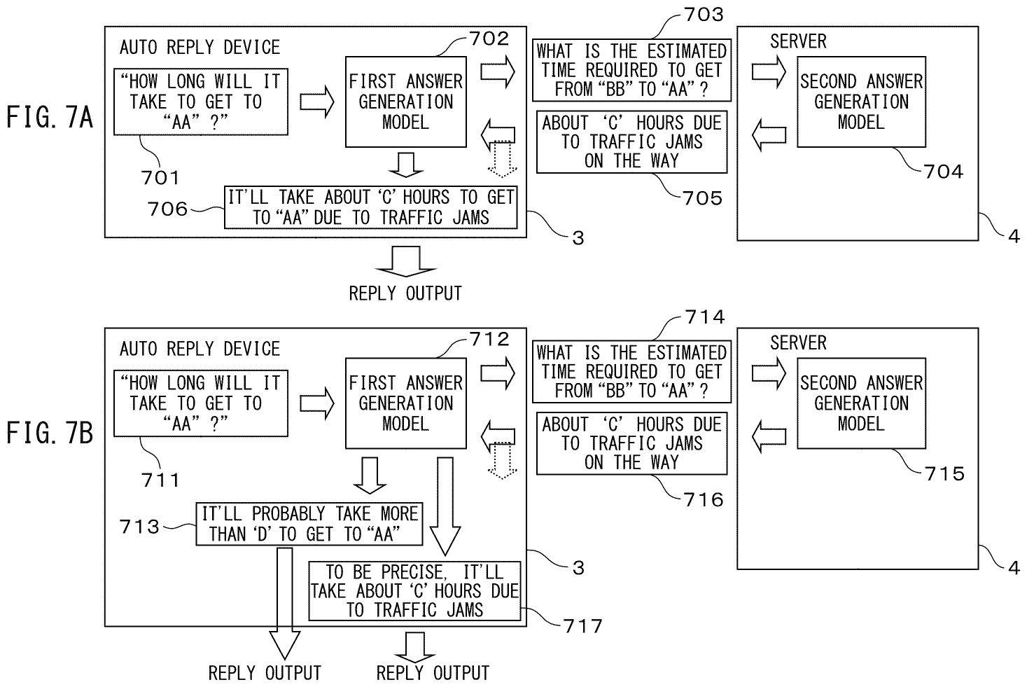

FIGS. 7A and 7B illustrate the auto reply process. In the example illustrated in FIG. 7A, input information 701 including voice information representing an occupant's utterance is inputted into a first generation model 702 in the auto reply device 3 of the vehicle 2 to generate inquiry information 703. The inquiry information 703 is transmitted to the server 4 and inputted into a second generation model 704 in the server 4 to generate second reply information 705. Upon receiving the second reply information 705 from the server 4, the auto reply device 3 executes a reply process to reply to the occupant, based on the second reply information 705. In this example, the auto reply device 3 may execute the reply process according to the second reply information 705 itself or third reply information 706 generated by the first generation model 702 in response to input of the second reply information 705 into the first generation model 702, as described above. In this example, the first reply information generated by the input information 701 being inputted into the first generation model 702 need not be used for the reply process, or may be inputted into the first generation model 702, together with the second reply information 705, to generate the third reply information 706. In this example, since the reply process is executed according to the reply information generated by the second generation model 704 larger than the first generation model 702, the auto reply system 1 can make a detailed or accurate reply. In this example, it is more preferable that the first generation model 702 be used for generating the inquiry information 703, or that the reply process be executed according to the third reply information 706 generated by the second reply information 705 being inputted into the first generation model 702. Since the use of the first generation model 702 for generating the inquiry information 703 clarifies the main point of the occupant's utterance in the inquiry information 703, as described above, the reply of the second reply information 705 generated based on the inquiry information 703 is more appropriate. Further, execution of the reply process according to the third reply information 706 enables the auto reply system 1 to reply more naturally, as described above.

In the example illustrated in FIG. 7B, input information 711 including voice information representing an occupant's utterance is inputted into a first generation model 712 in the auto reply device 3 of the vehicle 2 to generate first reply information 713 and inquiry information 714. The auto reply device 3 transmits the inquiry information 714 to the server 4 while executing a reply process based on the first reply information 713. In the server 4, the inquiry information 714 is inputted into a second generation model 715 to generate second reply information 716. Upon receiving the second reply information 716 from the server 4, the auto reply device 3 executes a reply process based on the second reply information 716 after the reply process based on the first reply information 713. In this example also, the auto reply device 3 may execute the reply process according to the second reply information 716 itself or third reply information 717 generated by the second reply information 716 being inputted into the first generation model 712, as described above. In this example also, the first reply information 713 may be inputted into the first generation model 712, together with the second reply information 716, to generate the third reply information 717. In this example, the reply process is executed first according to the first reply information 713 while the server 4 is generating the second reply information 716, which shortens a waiting time from an occupant's utterance until a first reply and thus reduces the occupant's stress. In addition, since the reply process according to the second reply information 716 or the third reply information 717 follows the reply process according to the first reply information 713, the occupant can receive a more detailed or accurate reply.

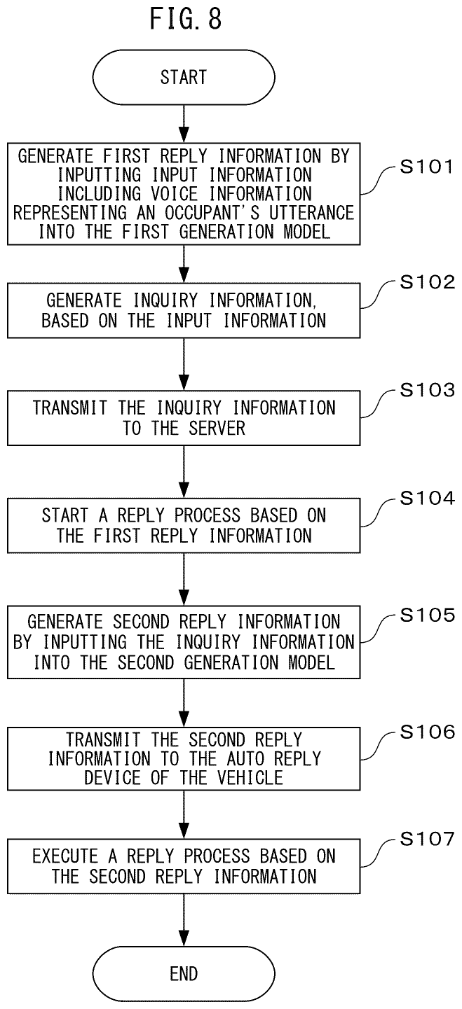

FIG. 8 is an operation flowchart of the auto reply process of the present embodiment. The processor 23 of the auto reply device 3 and the processor 44 of the server 4 execute the auto reply process in accordance with this operation flowchart.

The first reply generation unit 31 of the processor 23 of the auto reply device 3 generates first reply information by inputting input information including voice information representing an utterance of an occupant of the vehicle 2 into the first generation model (step S101). The first reply generation unit 31 further generates inquiry information, based on the input information (step S102). As described above, the input information may include an interior image, a sub-region representing the occupant in an interior image, or vehicle state information.

The transmission/reception processing unit 32 of the processor 23 of the auto reply device 3 transmits the inquiry information to the server 4 via the wireless communication terminal 13, the wireless base station 6, and the communication network 5 (step S103). The reply processing unit 33 of the processor 23 of the auto reply device 3 starts a reply process based on the first reply information (step S104).

The second reply generation unit 52 of the processor 44 of the server 4 generates second reply information by inputting the inquiry information into the second generation model (step S105). The transmission/reception processing unit 51 of the processor 44 of the server 4 transmits the second reply information to the auto reply device 3 via the communication network 5, the wireless base station 6, and the wireless communication terminal 13 of the vehicle 2 (step S106). When the auto reply device 3 receives the second reply information, the reply processing unit 33 executes a reply process based on the second reply information after the reply process based on the first reply information (step S107). As described above, the reply process based on the first reply information in step S104 may be omitted. In step S107, the reply processing unit 33 may execute the reply process, based on third reply information generated by inputting the second reply information into the first generation model.

As has been described above, the auto reply system can reply to an occupant's utterance appropriately by using a relatively large-scale generation model provided outside the vehicle. In addition, the auto reply system can shorten a waiting time until a reply to the occupant's utterance, while maintaining the appropriateness of the reply, by using a relatively small-scale generation model implemented in the vehicle in combination with the generation model on the server side.

The computer program for achieving the auto reply process of the above-described embodiment or modified examples may be provided, for example, in a form recorded on a computer-readable portable storage medium as a computer program product.

As described above, those skilled in the art may make various modifications according to embodiments within the scope of the present invention.

What is claimed is:

1. An auto reply system comprising an auto reply device mounted on a vehicle and a server provided outside the vehicle,
the auto reply device comprising:
a processor configured to:
generate first reply information to an utterance of an occupant of the vehicle by inputting input information including voice information representing the utterance into a first generation model, the first generation model being implemented in the vehicle and pre-trained to generate the first reply information,
generate inquiry information representing the utterance, based on the input information,
transmit the inquiry information to the server via a communication device mounted on the vehicle,
receive second reply information generated based on the inquiry information from the server; and
reply to the occupant, based on at least one of the first and second reply information,
the server comprising:
a processor configured to generate the second reply information by inputting the inquiry information into a second generation model, the second generation model being pre-trained to generate the second reply information and larger than the first generation model.

2. The auto reply system according to claim 1, wherein the first generation model is pre-trained to generate the inquiry information, together with the first reply information, depending on the input information, and
the processor of the auto reply device generates the inquiry information by inputting the input information into the first generation model.

3. The auto reply system according to claim 1, wherein the processor of the auto reply device makes a reply to the occupant, based on the generated first reply information, and further replies to the occupant after the reply, based on the second reply information received from the server.

4. The auto reply system according to claim 1, wherein the processor of the auto reply device generates third reply information by inputting the second reply information into the first generation model, and replies to the occupant, based on the generated third reply information.

5. The auto reply system according to claim 1, wherein the processor of the auto reply device notifies the occupant of a predetermined holding reply via a notification device mounted on the vehicle during a wait time from a reply to the occupant based on the first reply information until reception of the second reply information.

6. An auto reply method comprising:
generating first reply information to an utterance of an occupant of a vehicle by inputting input information including voice information representing the utterance into a first generation model, the first generation model being implemented in the vehicle and pre-trained to generate the first reply information;
generating inquiry information representing the utterance, based on the input information;
generating second reply information to the inquiry information by inputting the inquiry information into a second generation model provided outside the vehicle, the second generation model being pre-trained to generate the second reply information and larger than the first generation model; and
replying to the occupant, based on at least one of the first and second reply information.

7. A non-transitory recording medium that stores a computer program for auto reply, the computer program causing a computer to execute a process comprising:
generating first reply information to an utterance of an occupant of a vehicle by inputting input information including voice information representing the utterance into a first generation model, the first generation model being implemented in the vehicle and pre-trained to generate the first reply information;
generating inquiry information representing the utterance, based on the input information;
generating second reply information to the inquiry information by inputting the inquiry information into a second generation model provided outside the vehicle, the second generation model being pre-trained to generate the second reply information and larger than the first generation model; and
replying to the occupant, based on at least one of the first and second reply information.

8. An auto reply device comprising:
a processor configured to:
generate first reply information to an utterance of an occupant of a vehicle by inputting input information including voice information representing the utterance into a first generation model, the first generation model being implemented in the vehicle and pre-trained to generate the first reply information,
generate inquiry information representing the utterance, based on the input information,
transmit the inquiry information to a server provided outside the vehicle via a communication device mounted on the vehicle,
receive second reply information generated based on the inquiry information from the server; and
reply to the occupant, based on at least one of the first and second reply information.
